(19) United States
(12) Patent Application Publication
(10) Pub. No.: US 2025/0096369 A1
(43) Pub. Date: Mar. 20, 2025

(54) Battery Cell Housing for a Battery Cell of an Electric Energy Storage Device, and Battery Cell

(71) Applicant: Bayerische Motoren Werke Aktiengesellschaft, Muenchen (DE)

(72) Inventors: Franz FUCHS, Muenchen (DE); Manuel KAINZ, Muenchen (DE); Peter ROESCH, Muenchen (DE); Florian SOLDNER, Brannenburg (DE); Paul WINKLER, Muenchen (DE)

(21) Appl. No.: 18/832,572

(22) PCT Filed: Jan. 23, 2023
(86) PCT No.: PCT/EP2023/051461

§ 371 Date: Jul. 24, 2024

(30) Foreign Application Priority Data
Jan. 25, 2022 (DE) 10 2022 101 673.0

(51) Int. Cl. H01M 50/103; H01M 50/107; H01M 50/15; H01M 50/152; H01M 50/244

(52) U.S. Cl. CPC H01M 50/103; H01M 50/107; H01M 50/15; H01M 50/152; H01M 50/244; H01M 2220/20

(57) ABSTRACT

A battery cell housing for a battery cell of an electric energy storage device has a base element which is designed to arrange the battery cell housing on a base of the electric energy storage device. The base element can be adhered onto the base using an adhesive, and the base element has an adhesive surface for applying the adhesive and an embossed section for receiving excess adhesive. A battery cell is also described.

### BACKGROUND AND SUMMARY

The invention relates to a battery cell housing for a battery cell of an electrical energy storage device according to the preamble of the independent claim. The invention also relates to a battery cell.

The prior art already discloses so-called round, prismatic or pouch cells. These battery cells are usually anchored in a self-supporting structure, and consequently are not part of the load-supporting assembly. For this reason, in particular the design of the battery cells is not optimized, for example, to provide joining surfaces for the structural application. Problems do arise however during adhesive attachment of the battery cell, for example because there are excessive stresses in the adhesive on account of the small adhesive area. Furthermore, there are no defined zones for receiving excess adhesive, and so for example gumming up of a valve device may occur.

DE 60 302 634 T2 describes a bipolar battery with a bipolar electrode having a positive electrode layer on one side of a collecting foil and a negative electrode layer on the other side of the collecting foil; having a polymer electrolyte layer, which is disposed between the bipolar electrodes, and having an insulating layer, which is provided on a periphery of at least one side of the collecting foil, the insulating layer being a flexible and self-adhesive insulating film.

The object of the present disclosure is to provide a battery cell housing and a battery cell by way of which improved attachment to a base plate of an electrical energy storage device can be realized.

This object may be achieved by a battery cell housing and a battery cell according to the independent patent claims. Advantageous configurations are specified in the subclaims.

One aspect of the technology concerns a battery cell housing for a battery cell of an electrical energy storage device with a base element, which is designed for arranging the battery cell housing on a base plate of the electrical energy storage device. The base element is adhesively attachable to the base plate by an adhesive.

It is in this case provided that the base element has an adhesive area for applying the adhesive. The adhesive area is in particular specifically configured for applying the adhesive. The base element also has an embossed recess, in particular a specific embossed recess, for receiving excess adhesive.

Consequently, improved attachment of the battery cell housing to the base plate can be realized, since in particular the specifically configured adhesive area can be provided with the adhesive. Furthermore, an excess of adhesive can be received in the embossed recess within the base element.

In particular, the adhesive area has a surface area that is as flat as possible. The embossed recess in turn allows the excess adhesive to be received, and so for example a valve device of the battery cell does not become gummed up.

According to one advantageous configuration, the adhesive area is formed peripherally around the base element. In particular, a large surface area designed for the adhesive attachment to the base element can consequently be created. Consequently, a precise and firm connection can be realized between the base element and the base plate.

It has also proven to be advantageous if the adhesive area is formed at a rim of the base element. This allows an improved mechanical connection between the battery cell housing and the base plate to be realized. Furthermore, for example valve devices can be formed on the base element outside the rim region, and so for example outgassing of the battery cell can be realized.

In a further advantageous configuration, the embossed recess is formed peripherally around the base element. The embossed recess is in particular a recess or clearance within the base element, and so excess adhesive can be received. In particular, since for example the adhesive area is also formed peripherally around the base element, the excess adhesive can consequently be reliably received by the peripheral adhesive area.

In a further advantageous configuration, as seen from the rim, first the adhesive area is formed and then the embossed recess. If the battery cell housing is formed as a cylindrical battery cell housing, the adhesive area is located at the rim, and therefore has a greater radius than the embossed recess.

It has also proven to be advantageous if the embossed recess encloses a valve device in the base element. In particular, for example in the case of the configuration as a cylindrical battery, the valve device may for example be arranged centrally on the base element, in order consequently to be able to carry out reliable outgassing of the electrolyte from an interior space of the battery cell housing. Formed peripherally around this valve device, when viewed radially, is in turn the embossed recess, with the adhesive area in turn being formed peripherally around the embossed recess. Consequently, an arrangement of the base element on the base plate can be realized by way of the adhesive and the adhesive area, with excess adhesive being received by the embossed recess and the enclosure of the valve device consequently having the effect of preventing gumming up of the valve device.

According to a further advantageous configuration, the battery cell housing is a cylindrical form or a prismatic form. In particular, the battery cell housing according to the disclosure can consequently be designed both for a cylindrical form and for a prismatic form. As a result, the battery cell housing can be used highly flexibly, and reliable adhesive bonding is realized both in the case of cylindrical battery cells and in the case of prismatic battery cells.

In an advantageous configuration, the base element has a buckling region formed on a side wall of the base element. Consequently, in the case of a load, the energy can for example be reliably transferred from the buckling region into a wall of the battery cell housing. Escape of the electrolyte from the interior space may consequently be prevented, since the load can be actively transferred into the wall by way of the buckling region. The buckling region can then buckle out by way of a rotational movement and, as already mentioned, transfer the corresponding energy into the wall, whereby a stable battery cell housing can be realized.

In yet a further advantageous configuration, the adhesive area has a corrugated structure. The corrugated structure is substantially a series of triangular cuts in order to avoid the accumulation of material, in particular the adhesive. Consequently, a larger adhesive area is also created, and so there can be both improved reception of excess adhesive and development of greater adhesive force as a result of the increased adhesive area.

A further aspect of the disclosure concerns a battery cell for an electrical energy storage device with at least one first electrical pole, one second electrical pole and with the battery cell housing according to any previous aspect.

The disclosure also relates to an electrical energy storage device with a battery cell according to any previous aspect. The electrical energy storage device may for example be designed as a traction battery for an at least partially electrically operated motor vehicle or for a fully electrically operated motor vehicle. Therefore, a further aspect of the disclosure also concerns a motor vehicle with an electrical energy storage device according to any previous aspect.

Advantageous configurations of the battery cell housing may be regarded as advantageous configurations of the battery cell, the electrical energy storage device and the motor vehicle.

Further features of the technology emerge from the claims, the figures and the description of the figures. The features and combinations of features mentioned above in the description and the features and combinations of features mentioned in the description of the figures below and/or shown in the figures alone can be used not only in the respectively stated combination but also in other combinations or on their own.

The technology is now explained in more detail on the basis of a preferred exemplary embodiment and also with reference to the drawings.

### BRIEF DESCRIPTION OF THE DRAWINGS

FIG. 1 shows a schematic sectional view of an embodiment of a battery cell;

FIG. 2 shows an enlarged sectional view of the battery cell according to FIG. 1; and

FIG. 3 shows a schematic plan view of an underside of a battery cell housing.

In the figures, elements that are the same or functionally the same are provided with the same designations.

### DETAILED DESCRIPTION OF THE DRAWINGS

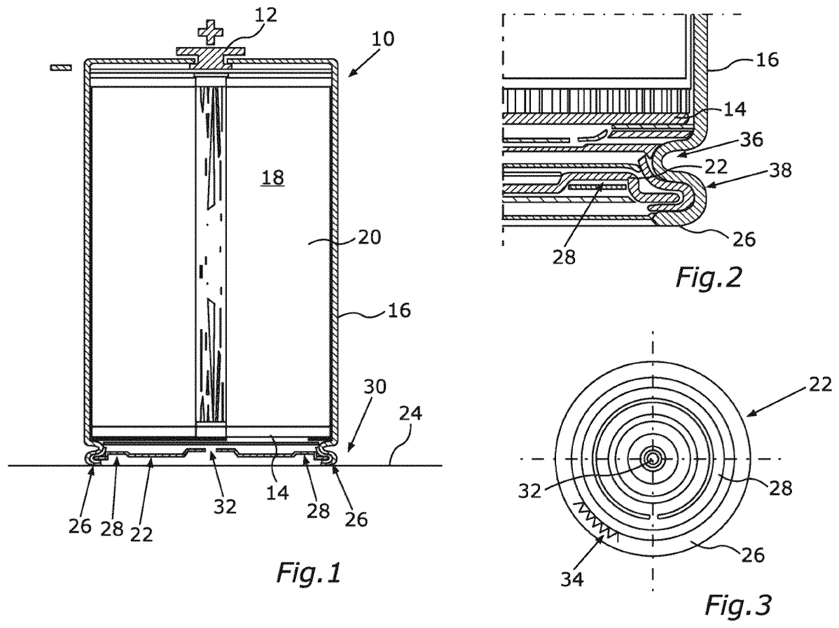

FIG. 1 shows a schematic sectional view according to one embodiment of a battery cell 10. The battery cell 10 has at least one first electrical pole 12, for example a positive pole, and one second electrical pole 14, for example a negative pole. The battery cell 10 also has a battery cell housing 16 and an interior space 18 formed from it, with an electrolyte 20 being contained in the interior space 18.

The battery cell 10 is designed in particular for an electrical energy storage device (not shown), with the electrical energy storage device being designed for example for an at least partially electrically operated motor vehicle or a fully electrically operated motor vehicle. The electrical energy storage device may then serve for example as a traction battery. For example, the battery cell 10 may be designed as a lithium-ion battery cell.

The battery cell housing 16 has a base element 22. The base element 22 is adhesively attachable to a base plate 24 of the electrical energy storage device by the adhesive.

It is provided that the base element 22 has a specifically configured adhesive area 26 for applying the adhesive and a specific embossed recess 28 for applying excess or superfluous adhesive.

In the present exemplary embodiment, the battery cell housing 16 is in particular a cylindrical form. Alternatively, the battery cell housing 16 may also be designed for a prismatic form.

In particular, FIG. 1 also shows that the adhesive area 26 is formed peripherally around the base element 22. The adhesive area 26 is formed in particular at a rim 30 of the base element 22. FIG. 1 also shows that the embossed recess 28 is formed peripherally around the base element 22 while also, as seen from the rim 30, first the adhesive area 26 is formed and then the embossed recess 28. Furthermore, it is shown in FIG. 1 that the embossed recess 28 encloses a valve device 32.

In particular, it is provided that the adhesive area 26 is maximized and to reduce wave formation during spreading inwardly may have for example a series of triangular cuts (see FIG. 3). The series of triangular cuts has the effect for example of preventing an accumulation of material. It is also provided in particular that the embossed recess 28 can receive the excesses of adhesive, with a size of the embossed recess 28 being defined for example by the minimum adhesive gap, application of adhesive for the maximum adhesive gap, the respective amount of adhesive, solution variables, the width of the adhesive area, the depth of the embossed recess and the position of the valve device 32.

In particular, the extension of the adhesive area 26 by way of creating pronounced curves back and forth and for example introducing the series of triangular cuts or a corrugated structure 34 (FIG. 3) is consequently provided in order to avoid the accumulation of material. The embossed recess, in other words the specific embossed recess 28, after the functional area of the adhesive area 26 is designed in order to receive the excess adhesive before it wets the valve area of the valve device 32.

In particular, as shown in FIG. 1, the adhesive area 26 may be crimped.

FIG. 2 shows a schematic enlarged view according to the embodiment from FIG. 1. In the present exemplary embodiment, it is shown in particular in an enlarged form that the base element 22 may additionally have a buckling region 36, with the buckling region 36 being formed on a side wall 38 of the base element 22. By way of the buckling region 36, in particular an axial transmission of the forces can be realized when a load is introduced. For example, a rotational movement may be provided when a load is applied, whereby the forces can be transferred to the wall of the battery cell housing 16, and for example damage to the electrolyte 20 can be prevented.

FIG. 3 shows a schematic view of the base plate 22 on an underside. In particular, it is shown in the present case that the adhesive area 26 may have the corrugated structure 34.

### LIST OF DESIGNATIONS

10 Battery cell
12 First electrical pole
14 Second electrical pole
16 Battery cell housing
18 Interior space
20 Electrolyte
22 Base element
24 Base plate
26 Adhesive area
28 Embossed recess
30 Rim
32 Valve device
34 Corrugated structure
36 Buckling region
38 Side wall

1-10. (canceled)

11. A battery cell housing for a battery cell of an electrical energy storage device, the battery cell housing comprising:
a base element designed for arranging the battery cell housing on a base plate of the electrical energy storage device, the base element being adhesively attachable to the base plate by an adhesive, wherein
the base element has an adhesive area for applying the adhesive and has an embossed recess for receiving excess adhesive.

12. The battery cell housing according to claim 11, wherein
the adhesive area is formed peripherally around the base element.

13. The battery cell housing according to claim 11, wherein
the adhesive area is formed at a rim of the base element.

14. The battery cell housing according to claim 11, wherein
the embossed recess is formed peripherally around the base element.

15. The battery cell housing according to claim 13, wherein
as seen from the rim, first the adhesive area is formed and then the embossed recess.

16. The battery cell housing according to claim 11, wherein
the embossed recess encloses a valve device in the base element.

17. The battery cell housing according to claim 11, wherein
the battery cell housing has a cylindrical form or a prismatic form.

18. The battery cell housing according to claim 11, wherein
the base element has a buckling region, the buckling region being formed on a side wall of the base element.

19. The battery cell housing according to claim 11, wherein
the adhesive area has a corrugated structure.

20. A battery cell for an electrical energy storage device, the battery cell comprising:
a first electrical pole;
a second electrical pole; and
the battery cell housing according to claim 11.
